(19) United States
(12) Patent Application Publication
(10) Pub. No.: US 2025/0208810 A1
(43) Pub. Date: Jun. 26, 2025

(54) METHOD AND SYSTEM FOR DISPLAYING CONTENT ON A LOCK SCREEN OF A COMPUTING DEVICE

(71) Applicant: Glance InMobi Pte. Ltd., Singapore (SG)

(72) Inventors: Devireddy Rajesh Krishna, Andhra Pradesh (IN); Rumit Anand, Maharashtra (IN); Rakesh Retnakaran, Kerala (IN); Anand Wadodkar, Nagpur (IN); Dinesh Kumar Chandramohan, Tamilnadu (IN); Pradeep Kumar Paijwar, Karnataka (IN); Shoaib Mohammed Ameer, Karnataka (IN)

(21) Appl. No.: 19/002,012

(22) Filed: Dec. 26, 2024

(30) Foreign Application Priority Data
Dec. 26, 2023 (IN) 202311088833
Dec. 20, 2024 (IN) 202411101359

(51) Int. Cl. G06F 3/14

(52) U.S. Cl. CPC G06F 3/14

(57) ABSTRACT

The present disclosure relates to a method and system for displaying content on a lock screen of a computing device. The method includes identifying one or more triggers at the at least one computing device. Next, at least one content is retrieved from a server associated with one or more external utilities in real-time. Furthermore, a display space is determined on a lock screen of the at least one computing device. The at least one content is dynamically displayed on the determined display space on the lock screen of the at least one computing device.

### TECHNICAL FIELD

The present disclosure generally relates to methods and systems of information technology and content delivery. More particularly, the present disclosure relates to a method and system for displaying a real time data at a display space on a lock screen of a computing device.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as an admission of prior art.

In the current era, technological advancement in smart user devices, notably mobile phones, has brought a transformative shift in how we access and interact with information. One significant evolution can be seen in the strategic utilization of the lock screen of a computing device such as a smartphone. A lock screen on the display of the computing device serve as a gateway to significant aspects of a user's life, majorly through notifications. Lock screen has served as a platform for displaying crucial information. The lock screen, once a mere barrier to access, has evolved into an informative hub that provides immediate insights without the requirement to unlock the device. By leveraging the lock screen as a utilitarian space, individuals can efficiently stay informed and organized, streamlining their lives in an era defined by the rapid exchange of information.

The existing mechanism for notifications on lock screens fall short of providing a real-time information. The existing mechanism has a restricted capability of exclusively showcasing data from utility only from the sources like user applications, often presenting outdated and non-real-time information. They are confined to delivering messages from installed applications without considering the broader scope of the user's activities and interests. This limitation prevents the lock screen from serving as an interactive and personalized interface for the user of the computing device that can offer timely experiences based on the user's preferences.

Moreover, the existing mechanisms on lock screens are designed with predefined rules set by developers of each application. As a result, notifications are often delivered at times or in contexts that may not be relevant to the user. This approach not only disrupts the user experience but also results in delays in accessing timely and pertinent information. As the technology advances, these problems have become more visible. The above-mentioned problems highlights the need for a solution to seamlessly provide real-time data updates without constant user intervention.

Therefore, there are a number of limitations to the existing solutions and in order to overcome these and such other limitations of the known solutions it is necessary to provide an efficient solution for displaying a real time data on a lock screen of a user device.

### SUMMARY OF THE DISCLOSURE

This section is provided to introduce certain aspects of the present disclosure in a simplified form that are further described below in the detailed description. This summary is not intended to identify the key features or the scope of the claimed subject matter.

An aspect of the present disclosure may relate to a method for displaying content on lock screen of at least one computing device. The method includes identifying, by a processing unit, one or more triggers at the at least one computing device. Furthermore, the method includes retrieving in real-time, by the processing unit, at least one content from a server associated with one or more external utilities. Thereafter, the method includes determining, by the processing unit, a display space on the lock screen of the at least one computing device based on the one or more triggers. Hereinafter, the method includes dynamically displaying, by the processing unit, the at least one content on the determined display space on the lock screen of the at least one computing device.

In an exemplary aspect of the present disclosure, the retrieving is based on at least one of one or more user attributes associated with a user of the at least one computing device, a contextual state of the at least one computing device, and one or more predefined criterion.

In an exemplary aspect of the present disclosure, the one or more triggers include one or more of a lock screen state and a user inactivity.

In an exemplary aspect of the present disclosure, the display space includes of a pre-determined area on the lock screen of the at least one computing device, and the at least one content is displayed on the pre-determined area In an exemplary aspect of the present disclosure, the at least one content is displayed in one of a custom format and a predetermined format on the determined display space on the lock screen of at least one the computing device, each format comprising at least one of an image, a tag, a main text and a subtext.

Another aspect of the present disclosure may relate to a system for displaying content on a lock screen of at least one computing device. The system includes a processing unit. The processing unit is configured to identify one or more triggers at the at least one computing device. The processing unit is further configured to retrieve, in real-time, at least one content from a server associated with the one or more external utilities. Furthermore, the processing unit is configured to determine a display space on a lock screen of the at least one computing device based on the one or more triggers. The processing unit is further configured to display dynamically the at least one content on the determined display space on the lock screen of the at least one computing device.

Yet another aspect of the present disclosure may relate to a non-transitory computer readable storage medium storing instructions for displaying a content on at least one computing device, the instructions include executable code which, when executed by one or more units of a system, cause a processing unit of the system to identify one or more triggers at the at least one computing device. The instructions when executed by the system further cause to retrieve, in real-time, at least one content from a server associated with the one or more external utilities. The instructions when executed by the system further cause to determine a display space on a lock screen of the at least one computing device based on the one or more triggers. The instructions when executed by the system further cause to display dynamically the at least one content on the determined display space on the lock screen of the at least one computing device.

### OBJECTS OF THE DISCLOSURE

This section is provided to introduce certain objects and aspects of the present invention in a simplified form that are further described below in the description. In order to overcome at least a few problems associated with the known solutions as provided in the previous section, an object of the present invention is to substantially reduce the limitations and drawbacks of the prior arts as described hereinabove.

An object of the present invention is to provide a solution for displaying content in real time at a display space on a lock screen of a computing device.

Another object of the present invention is to provide a method for displaying a content at a display space on a lock screen of a computing device for an application or utility which is not present on the computing device.

Yet another object of the present invention is to provide a solution that displays the content at a display space on a lock screen of a computing device for a utility does not present on the user device without any user intervention.

Yet another object of the present invention is to provide a solution that updates the content at a display space on a lock screen of a user device for a utility that is not present on the computing device without any user interaction.

Yet another object of the invention is to provide a solution that dynamically updates the display space on a lock screen of a user device without any user interaction to display the content at a display space on a lock screen of a user device for a utility that is not present on the computing device.

### BRIEF DESCRIPTION OF DRAWINGS

The accompanying drawings, which are incorporated herein, constitute a part of this disclosure. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components or circuitry commonly used to implement such components. Although exemplary connections between sub-components have been shown in the accompanying drawings, it will be appreciated by those skilled in the art that other connections may also be possible, without departing from the scope of the invention. All sub-components within a component may be connected to each other, unless otherwise indicated.

FIG. 1 illustrates an exemplary system [100] for displaying a content on a computing device, in accordance with exemplary embodiments of the present invention.

FIG. 2 illustrates an exemplary method [200] for displaying a content on a computing device, in accordance with exemplary embodiments of the present invention.

FIG. 3 illustrates an exemplary method [300] for delivering content to the user via computing device, in accordance with exemplary implementations of the present disclosure.

FIG. 4 illustrates an exemplary method [400] for gathering content to publish for the user, in accordance with exemplary implementations of the present disclosure.

FIG. 5 illustrates a visual representation [500] of the content displayed on the lock screen, in accordance with exemplary implementations of the present disclosure.

### DETAILED DESCRIPTION OF THE DISCLOSURE

In the following description, for the purposes of explanation, various specific details are set forth in order to provide a thorough understanding of the embodiments of the present invention. It will be apparent, however, that embodiments of the present invention may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present invention are described below, as illustrated in various drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes”, “has”, “contains”, and other similar words are used in either the detailed description or the claims, such terms are intended to be inclusive—in a manner similar to the term “comprising” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a (Digital Signal Processing) DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a computing device”, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from at least one of a transceiver unit, a processing unit, a storage unit, a detection unit and any other such unit(s) which are required to implement the features of the present disclosure.

As used herein, “storage unit”, “database”, or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

All modules, units, components used herein, unless explicitly excluded herein, may be software modules or hardware processors, the processors being a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASIC), Field Programmable Gate Array circuits (FPGA), any other type of integrated circuits, etc.

As discussed in the background section, the current known solutions have several shortcomings. In the current known solutions, the lock screen has restricted capabilities of showcasing data from an application or utility, only from the sources like user applications which often presents outdated and non-real-time information. The present invention relates to a novel method and system for displaying a real time data at a display space on a lock screen of a computing device. More particularly, the methods and systems of the present invention is an innovative and novel solution aimed for displaying a real time data at a display space on a lock screen of a user device by facilitating the retrieval of a set of real-time data from a server unit through an inventive process that revolves around assessing the available display area on the lock screen. This innovation goes beyond the conventional methods by enabling the retrieval of real-time data from the server even when the corresponding utility isn't accessible or present on the user's device. Furthermore, the solution encompasses scenarios where data can be acquired from the server without requiring any direct user intervention. Subsequently, the processing unit seamlessly showcases at least one real-time data item from the retrieved content directly onto the lock screen's display space, even when user interaction is absent, thereby enhancing both the user experience and the accessibility of critical information. Moreover, in a practical implementation of this solution, the display of real-time data on the lock screen can dynamically update in real time, influenced by factors such as predefined time intervals or user-initiated actions like refreshing the lock screen via the power key. Additionally, the solution can extend to dynamic updates of the lock screen's display space, influenced by data parameters such as the size of each real-time data item. This multi-faceted approach signifies a significant leap forward in enhancing user engagement.

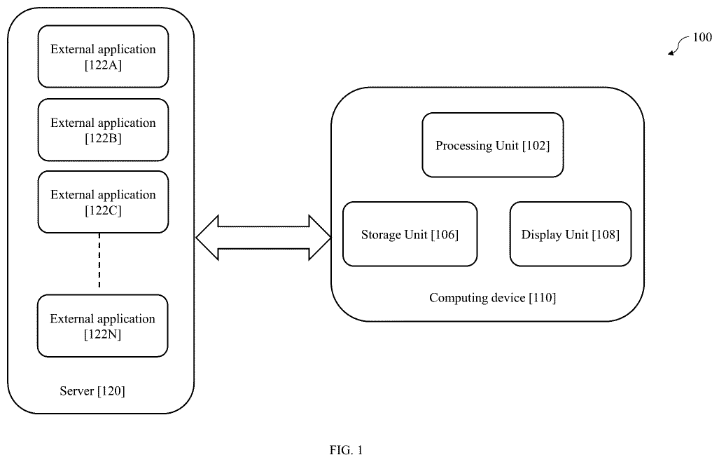

Referring to FIG. 1, an exemplary system [100] for displaying a content on a computing device, in accordance with exemplary embodiments of the present invention is shown. In an implementation the system [100] performs the method [200]. Further, in an implementation, the system [100] may be present in a server device to implement the features of the present disclosure. The system [100] includes of at least one computing device [110] further comprising at least one processing unit [102], at least one storage unit [104] and at least one display unit [106]. The system [100] further includes of a server [120] associated with one or more utilities [122A, 122B, 122C, . . . 122N, hereinafter collectively referred to as 122]. Also, all of the components/units of the system [100] are assumed to be connected to each other unless otherwise indicated below. As shown in the figures all units shown within the system should also be assumed to be connected to each other. Also, in FIG. 1 only a few units are shown, however, the system [100] may include multiple such units or the system [100] may include any such numbers of said units, as required to implement the features of the present disclosure. Further, in an implementation, the system [100] may be present in a computing device [110] to implement the features of the present disclosure. The system [100] may be a part of the computing device [110]/or may be independent of but in communication with the computing device [110].

Also, it is pertinent to note that the system [100] is exemplary, and the system [100] may work in conjunction with, one or more modules/units as required and/or as obvious to a person skilled in the art, to implement the features of the present disclosure. The system [100] is configured for displaying content on a lock screen of a computing device [110], with the help of the interconnection between the components/units of the system [100].

In order to display a content on lock screen of at least one computing device [110], the processing unit [102] of the system [100] is configured to identify one or more triggers at the at least one computing device [110]. In an implementation of the present disclosure, identifying the one or more triggers may be identification of a lock screen state at the computing device [110]. The one or more triggers may also be an inactive state of the computing device [110], i.e. the user is currently not interacting with the at least one computing device [110].

Further, the processing unit [102] of the system [100] is configured to retrieve at least one content from the server [120] associated with the one or more external utilities [122] in real-time. The one or more external utilities [122](e.g., applications) are outside the at least one computing device [110] and may not be present on the at least one computing device [110]. The one or more external utilities (e.g., applications) may be one of a first party provider, a second party provider, a third-party provider and an information in an operation system (OS) of the at least one computing device [110].

The first party provider refers to an entity that collects data directly from users and sends curated content. In one example, the first party provider may be one of a health application. The first party application tracks the calories consumed and types of food eaten to provide personalised recommendations. The second party provider refers to an entity sending their content. For example, a weather application shares a partnered application for obtaining AQI index. The third-party provider refers to collection of data from multiple sources where the third-party provider has direct relationship with the user. In one example, a third-party provider collects data from multiple shopping applications to curate personalised content. In an implementation of the present disclosure, the processing unit [102] may establish a connection with one or more external utilities [122] via a server to server (S2S) application programming interface (API).

In an implementation of the present solution, the at least one content is not available at the computing device [110]. The at least one content may be a data associated with the one or more external utilities (e.g., applications) that are not available at the computing device [110]. For instance, a shopping data associated with external application A, where the user may have external application B but not the external application A, a stock value data associated with User Application C, wherein the user device does not have the user application C, a user physical activity data associated with User Application X, wherein user device does not have the user application X, etc.

Further, in an implementation of the present solution, the at least one content retrieved may be associated with an application without any user activity and/or a user input at the computing device [110]. The at least one is content is retrieved based on one or more of the predefined criteria and the contextual state of the at least one computing device [110]. For instance, the predefined criteria to retrieve may include retrieving the at least one content in a predetermined format such as a text format, an image format, a text-image format, a gif format, etc.

The processing unit [102] is further configured to retrieve the at least one content in real time based on at least one of one or more user attributes associated with the user of the at least one computing device [110]. The user attributes include but may not be limited to geographical location, age, user behavior data, and the like. For instance, if a user is using a fitness application, the behavioral data may be used to recommend a healthy food application. For another instance, if a user has brought a phone from a shopping application, the behavioral data may indicate that the user will need a charger, a phone cover, and the like.

In an implementation of the present disclosure, before retrieving the at least one content, the processing unit [102] is further configured to collect information pertaining to the user activity and the user history. The processing unit [102] may further collect information pertaining to a context of the user through the at least one computing device [110] at any given point of time. Based on the collection of the user context, the processing unit [102] may retrieve personalised content from the one or more utilities [122].

In an implementation of the present disclosure, the content retrieved from the one or more external applications is stored in a database [106] after moderation. The process of moderation includes but may not be limited to filtering out proprietary information of the first party provider, the second party provider and the third party provider.

The processing unit [102] is further configured to determine the display space on the lock screen of the computing device [110]. The display space is determined based on the one or more triggers. In an implementation of the present solution, the display space may include a portion of the lock screen. In another implementation of the present solution, the display space may include an entirety of the lock screen. In another implementation of the present solution, the display space may be the pre-determined area of an output unit on the computing device [110]. In another implementation of the present solution, the display space may be the area of the display on the computing device [110] determined in real time.

In an implementation of the present disclosure, the processing unit [102] is further configured to process the at least one content to transform at least one data parameter of the at least one content in the predefined data format to generate the transformed content. Further, the processing unit [102] may be configured to generate the transformed content based on determining the display space on the lock screen of the user device. For e.g., the processing unit [102] may process the content to transform the size parameter of the content, such as to match the size parameter of the determined display space. In an implementation of the present disclosure, the retrieving of the at least one content in real-time from the one or more external applications may also be based on the determined display space. For e.g., the processing unit [102] may only retrieve such content from the server [120] depending on the determined display space.

The processing unit [102] is further configured to display the transformed content dynamically on the lock screen of the at least one computing device [110]. The customized template may be utilized by to display the transformed content on the determined display space on the lock screen of the at least one computing device [110]. The customized template includes but may not be limited to an image, a tag, a main text and a subtext. In one implementation of the present disclosure, the customized template may be created using template creation applications.

In another implementation of the present disclosure, the processing unit [102] may retrieve a set of content pertaining to different utilities. Further, the processing unit [102] may display a plurality of content from a set of content simultaneously at the display space on the lock screen. Furthermore, in another implementation of the present solution, the processing unit [102] may display one or more content from the set of content at a predefined interval of time at the display space on the lock screen. Furthermore, in another implementation of the present solution, the processing unit [102] may display one or more content from the set of content at the display space on the lock screen based on a priority level associated with each content from the set of content. The priority level of each of the content may be based on at least one of the one or more user attributes and the computing device [110] attributes.

In an implementation of the present disclosure, the content may further be sent to the metadata. For instance, the metadata provides information to the system operator or administrator about the content selected the highest number of times by the user from the set of data. The gathering of the metadata allows the processing unit [102] to score relevancy of content for each user and provide personalized content for each user based on their preferences and history.

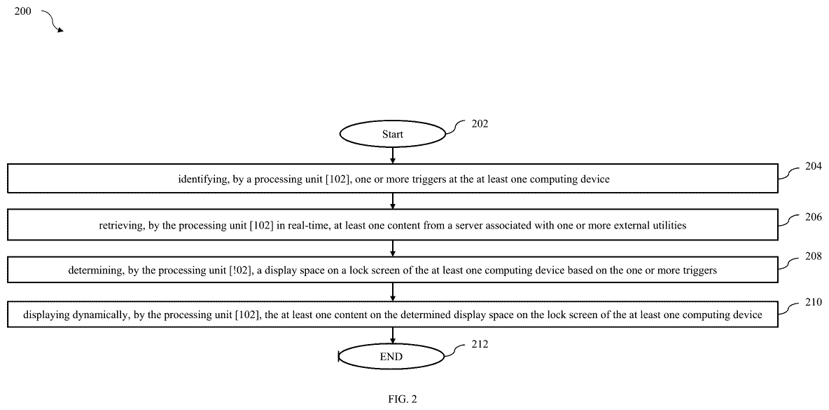

Referring to FIG. 2, an exemplary method flow diagram [200] for displaying a content on a lock screen of the at least one computing device, in accordance with exemplary implementations of the present disclosure is shown. In an implementation the method [200] is performed by the system [100] as depicted hereinabove in FIG. 1. As shown in FIG. 1, the method [200] starts at step [202].

At step [204], the method includes identifying one or more triggers at the at least one computing device [110] by the processing unit [102]. In an implementation of the present disclosure, identifying the one or more triggers may include identification of a lock screen state at the at least one computing device [110]. In an implementation of the present disclosure, the one or more triggers may be an inactive state of the computing device, i.e. the user is currently not interacting with the computing device [110].

Next, at step [206], the method includes retrieving at least one content from a server [120] associated the one or more external utilities [122](e.g., applications) in real-time. The method of retrieving is performed by the processing unit [102]. In an implementation of the present solution, the at least one content is not available at the computing device. The at least one content may be a data associated with the one or more external applications that are not available at the computing device. For instance, a shopping data associated with external application A, where the user may have external application B but not the external application A, a stock value data associated with User Application C, wherein the user device does not have the user application C, a user physical activity data associated with User Application X, wherein user device does not have the user application X, etc.

The present disclosure encompasses that the one or more external utilities [122](e.g., applications) are outside the at least one computing device [110]. The one or more external applications may be one of a first party provider, a second party provider, a third-party provider, and an information in an operation system (OS) of the computing device [110]. The first party provider refers to an entity that collects data directly from users and sends curated content. In one example, the first party provider may be one of a health application. The first party application tracks the calories consumed and types of food eaten to provide personalised recommendations. The second party provider refers to an entity sending their content. For example, a weather application shares a partnered application for obtaining AQI index. The third-party provider refers to collection of data from multiple sources where the third-party provider has direct relationship with the user. In one example, a third-party provider collects data from multiple shopping applications to curate personalised content.

Further, in an implementation of the present solution, the at least one content retrieved may be associated with an application without any user activity and/or a user input at the computing device [110]. The retrieving is based on one or more of a predefined criteria and a contextual state of the at least one computing device. The predefined criteria refer to a set of rules to retrieve the at least one content from the one or more external applications. The predefined criteria may be defined by a system operator or administrator. For instance, the predefined criteria to retrieve may include retrieving the at least one content by the processing unit, in a predetermined format such as a specific text format, an image format, a text-image format, a gif format, etc.

The retrieving is further based on at least one of one or more user attributes associated with a user of the at least one computing device. The user attributes include but may not be limited to geographical location, age, user behavior data, and the like. For instance, if a user has brought a phone from a shopping application, the behavioral data may indicate that the user will need a charger, a phone cover, and the like. For another instance, if a user is using a fitness application, the behavioral data may be used to recommend a healthy food application.

In an implementation of the present disclosure, before retrieving the at least one content, the processing unit [102] may collect information pertaining to user activity and user history. The processing unit [102] may further collect a user context of the user through the computing device [102] at any given point of time. Based on the collected information pertaining to the user context, a personalised content may be fetched.

In an implementation of the present disclosure, the content retrieved from the one or more external applications will be stored in a database [106] after moderation. The process of moderation includes but may not be limited to filtering out proprietary information of the first party provider, the second party provider and the third party provider.

Further, at step [208], the method includes determining the display space on a lock screen of the computing device [110] by the processing unit [102]. The display space is determined based on the identification of the one or more triggers. In an implementation of the present solution, the display space may include a portion of the lock screen. In another implementation of the present solution, the display space may include an entirety of the lock screen. In another implementation of the present solution, the display space may be a pre-determined area of an output unit on the computing device. In another implementation of the present solution, the display space may be an area of a display on the computing device. The display may also be determined in real time.

In an implementation of the present disclosure, the at least one content may be further processed by the processing unit [102] to transform at least one data parameter of the at least one content in a predefined data format to generate a transformed content. Further, the transformed content may be generated by the processing unit [102] based on determining the display space on the lock screen of the user device. For e.g., the content may be processed by the processing unit [102] to transform the size parameter of the content, such as to match the size parameter of the determined display space. In another implementation of the present disclosure, the retrieving of the at least one content in real-time from the one or more external utilities [122](e.g., applications) may also be based on the determined display space. For e.g., the processing unit [102] may only retrieve such content from the server [120] depending on the determined display space.

Further at step [210], the method includes displaying the transformed content on the determined display space dynamically on the lock screen of the computing device [110]. The content is displayed by the processing unit [102]. The transformed content is displayed in a customised template on the determined display space on the lock screen of the at least one computing device. The customized template includes but may not be limited to an image, a tag, a main text and a subtext. In one implementation of the present disclosure, the customized template may be created using template creation applications.

In another implementation of the present disclosure, the processing unit [102] may retrieve a set of content pertaining to different utilities. A plurality of content from said set of content may be displayed simultaneously by the processing unit [102] at the display space on the lock screen. Furthermore, in another implementation of the present solution, one or more content from the set of content may be displayed at a predefined interval of time by the processing unit [102] at the display space on the lock screen. Furthermore, in another implementation of the present solution, one or more content from the set of content may be displayed by the processing unit [102] at the display space on the lock screen based on a priority level associated with each content from the set of content, wherein the priority level of each of the content may be based on at least one of the one or more user attributes and the computing device attributes.

In an implementation of the present disclosure, the content may further be sent to a metadata. The metadata refers to gathering information of the content. For instance, the metadata provides information to the system operator or administrator about the content selected the highest number of times by the user from the set of data. Gathering metadata allows the processing unit to score relevancy of content for each user and provide personalized content for each user based on their preferences and history.

The method terminates at step [212].

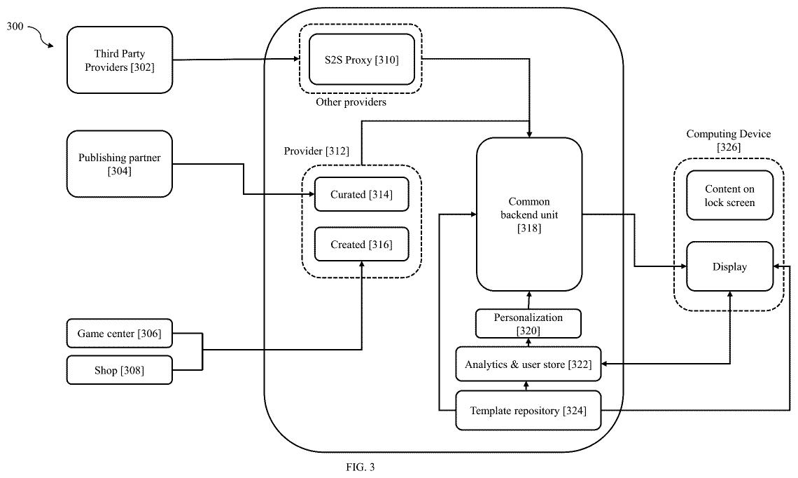

Referring to FIG. 3, an exemplary method [300] for delivering content to the user via a computing device, in accordance with exemplary implementations of the present disclosure is shown.

The content is received from one or more third-party providers [302]. The content may be received via a Server to server (S2S) proxy [310]. The content is received at a common backend [318]. The S2S proxy [310] refers to an interface for sharing data securely between a client server and a target server. The S2S proxy [310] allows for smooth communication between both the servers without user intervention. Here, the target server is the common backend unit [318], and the client server is the one or more third-party providers [302]. The common backend unit [318] requests the content via the S2S API [310] from the one or more third-party providers [302].

Further, a publishing partner [304], a game application [306], a shop application [308] or alike may send the content to a provider [312]. The provider [312] may curate and create the content based on user preferences and user history to make it relevant to the user. The curation and creation of the content includes but may not be limited to moderation of the content to hide proprietary information, and the like. Further, after creation and curation of the content, the content is sent to the common backend unit [318].

The common backend unit [318] is the entity responsible for channelling the content for a user from different external applications. At the common backend unit [318], a customized template will be selected from a template repository [324]. The template repository [324] contains multiple templates prepared via a template creation application. A template is created for each category of utility or application. For instance, a template A is created for shopping utility which has an image, a tag, a main text, a sub-text and a background, template B is created for health utility applications which has an image, a main-text and background in a different layout. A template will be selected based on the category of the content. Once the template is selected, the template may be modified and curated according to user analytics collected in an analytics and user store [322].

The analytics and user store [322] is connected with a computing device [326] of the user. The analytics and user store [322] may apply an algorithm to collect user activity and user history. The algorithm may collect the user context of the user at any given point of time. The user context may be used to modify or curate the template based on the collection of the user context.

Furthermore, the content and the templated may be personalized based on the user analytics and user history at a personalization unit [320]. The personalized content in the template may be sent to the common backend unit [318]. The common backend unit [318] is in communication with the computing device [326]. The common backend unit [318] publishes the content on the lock screen of the computing device [326] after determining the display space on the lock screen.

In an implementation of the present disclosure, a plurality of content from a set of content may be displayed simultaneously at the display space on the lock screen. Furthermore, in another implementation of the present solution, one or more content from the set of content may be displayed at a predefined interval of time at the display space on the lock screen. Furthermore, in another implementation of the present solution, one or more content from the set of content may be displayed at the display space on the lock screen based on a priority level associated with each content from the set of content, wherein the priority level each real time data may be based on at least one of the one or more user attributes and the user device attributes.

In an implementation of the present disclosure, the content is also sent to a metadata. The metadata refers to gathering information of the content. For instance, the metadata provides information to the system operator or administrator about the content selected the highest number of times by the user from the set of data. Gathering metadata allows to score relevancy of content for each user and provide personalized content for each user based on their preferences and history.

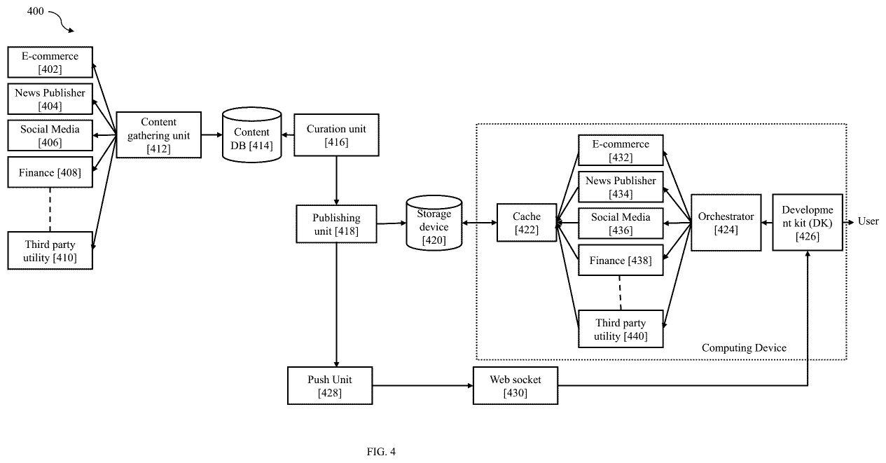

Referring to FIG. 4, an exemplary method [400] for gathering content to publish for the user, in accordance with exemplary implementations of the present disclosure is shown.

A content gathering unit [412] may be deployed to collect the content from the one or more publishing partners through information available from them. The one or more publishing partners include but may not be limited to an electronic commerce (E-commerce) [402], a news publisher [404], a social media [406], a financial data [408], and the like. The content is further forwarded to a content database (content DB) [414].

The content stored in the content DB [414] is further collected by a curation unit [416]. At the curation unit [416], the content may be tailored and moderated. The tailoring and moderation includes but may not be limited to hiding proprietary information. Further the moderated content may be transferred to a publishing unit [418]. The moderated content may be published to users the. The publishing unit [418] further sends the content to two different units, namely a push unit [428] and a storage device [420].

At the storage device [420], the content published by the publishing unit [418] is collected and stored. The storage device [420] further includes a number of templates for each category of utility. For instance, a template A for shopping utility, a template B for finance utility, and the like. The template will be selected based on the category of the published content and the content will be stored in the selected template for display.

At the push unit [428], the content gathered from the one or more external applications may be sent via the service-to-service application programming interface (S2S API). The S2S API ensures that the content relevant to the user may be sent within the one or more external applications at the user level. Further, the push unit [428] may forward the content to a web socket [430]. In an implementation of the present disclosure, the web socket [430] may be one of a push notification service and a message queue. In an implementation of the present disclosure, the push notification service may be a firebase cloud messaging. In another implementation of the present disclosure, the push notification service may be any other service. In an implementation of the present disclosure, the message queue may be a kafka. In another implementation of the present disclosure, the message queue may be any other message queue. The push notification service pushes the content from a central server to multiple client servers. The message queue publishes the content, and the content may be consumed by multiple client servers. The web socket [430] may send the content to a development kit (DK) [426].

The DK [426] collects a personal information of the user once to use it across one or more applications that may be displayed on the lock screen of the computing device of the user. The one or more applications may be one of an electronic commerce utility [432], a news publisher utility [434], a social media utility [436], a finance utility [438], any other third party utility [440]. The personal information includes but may not be limited to name, age, gender, address, preferences. In one implementation, the DK [426] may collect the information under individual consent policies.

The DK [426] requests an orchestrator [424] to update the published content received via the web socket [430] in the one or more applications displayed on the lock screen of the computing device. The one or more applications may access the published data from a cache [422] to update the content on the lock screen of the display of the computing device in real time.

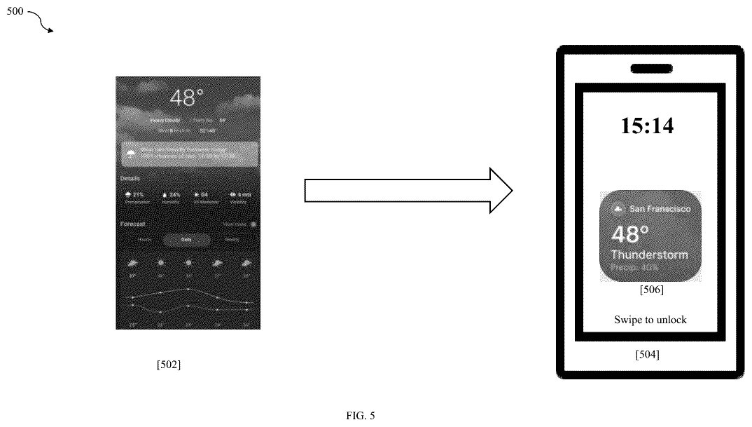

Referring to FIG. 5, a visual representation [500] of the content displayed on the lock screen, in accordance with exemplary implementations of the present disclosure is shown.

As shown in FIG. 5, a screen [502] of a weather utility at a specific geographic location (San Franscisco) is shown. The screen [502] includes at least one content. The at least one content includes but may not be limited to a temperature, a feel like temperature, a percentage of precipitation, humidity, ultraviolet rays, visibility and a graph of temperature at different intervals of time in a day.

In an implementation of the present disclosure, the at least one content of the screen [502] may be displayed on a lock screen of a computing device, only if the user has accepted to install it in their computing device. In an exemplary implementation of the present disclosure, the computing device is a smartphone [504], a smart television, a smart watch or alike.

The system [100] as shown in FIG. 2, may access and gather the at least one content of the weather utility using the content gathering unit [412]. The at least one content may be gathered in real-time to enhance user experience. In an implementation of the present solution, the at least one content retrieved may be associated with an application without any user activity and/or a user input at the computing device. The at least one is content is retrieved based on one or more of the predefined criteria and the contextual state of the at least one computing device. For instance, the predefined criteria to retrieve may include retrieving the at least one content in a predetermined format such as a text format, an image format, a text-image format, a gif format, etc. Further, the at least one content may be retrieved based on at least one of one or more user attributes associated with the user of the at least one computing device. The user attributes include but may not be limited to geographical location, age, user behavior data, and the like. For instance, if a user is using a fitness application, the behavioral data may be used to recommend a healthy food application.

The system [100] further, may store the content and curate or moderate the gathered content to hide proprietary information of the weather utility. Once the content is moderated, the system [100] may determine the display space on the lock screen. The display space is determined based on the identification of the trigger. The display space includes but may not be limited to the pre-determined area on the lock screen of the at least one computing device. In an implementation of the present solution, the display space may include a portion of the lock screen. In another implementation of the present solution, the display space may include an entirety of the lock screen. In another implementation of the present solution, the display space may be the pre-determined area of an output unit on the computing device. In another implementation of the present solution, the display space may be the area of the display on the computing device determined in real time.

The at least one content may be displayed to the user in a customized template [506] in the smartphone [504]. The customized template may be selected from a plurality of templates stored in the storage unit and may be customized according to relevancy of the content for the user based on analysis of the user activity and the user history.

In an implementation of the present disclosure, a plurality of content from a set of content may be displayed simultaneously at the display space on the lock screen of the smartphone [504]. Furthermore, in another implementation of the present disclosure, one or more content from the set of content may be displayed at a predefined interval of time at the display space on the lock screen. Furthermore, one or more content from the set of content may be displayed at the display space on the lock screen based on a priority level associated with each content from the set of content. The priority level of each of the content may be based on at least one of the one or more user attributes and the computing device attributes.

In an implementation of the present disclosure, the content may further be sent to the metadata. For instance, the metadata provides information to the system operator or administrator about the content selected the highest number of times by the user from the set of data. The gathering of the metadata allows to score relevancy of content for each user and provide personalized content for each user based on their preferences and history.

The present disclosure further discloses a non-transitory computer readable storage medium storing instructions for displaying a content on at least one computing device, the instructions include executable code which, when executed by one or more units of a system, cause a processing unit [102] of the system to identify one or more triggers at the at least one computing device. The instructions when executed by the system further cause an establishing unit [104] to establish a connection with one or more external applications. The instructions when executed by the system further cause the processing unit [102] to retrieve in real-time at least one content from the one or more external applications. The instructions when executed by the system further cause the processing unit [102] to determine a display space on a lock screen of the computing device based on the identification of trigger. The instructions when executed by the system further cause the processing unit [102] to display dynamically the at least one content the determined display space on the lock screen of the computing device.

As is evident from the above, the present disclosure provides a technically advanced solution for displaying a content on a computing device. The present invention provides a significant technical advancement in the field of delivering data to user devices by leveraging an approach centred on evaluating the available display area on a lock screen. This innovation enables the seamless extraction of the content from external applications. Notably, it breaks away from conventional norms by allowing the retrieval of such data even when the relevant utility isn't accessible on the computing device. Moreover, the solution adapts effortlessly to scenarios where data acquisition occurs without direct user involvement. The processing unit skilfully presents the content snippet from the collected set directly onto the lock screen, transforming information from the server into an accessible format. Remarkably, this transformation takes place without relying on user interaction, thus enhancing both the user experience and the accessibility of vital information. Practical implementation of this solution introduces further dynamism: real-time updates to the lock screen's displayed data, influenced by variables such as predefined time intervals or user-triggered actions like power key refreshes. Additionally, the solution extends its impact to the visual aspect, allowing the lock screen's display area to evolve dynamically based on parameters like the size of each real-time data element. This multifaceted innovation ushers in a significant advancement, revolutionizing the way information is presented and engaging users in novel ways.

While the present invention has been described with reference to certain preferred embodiments and examples thereof, other embodiments, equivalents and modifications are possible and are also encompassed by the scope of the present disclosure.

We claim:

1. A method for displaying content on a lock screen of at least one computing device, the method comprising:
identifying, by a processing unit, one or more triggers at the at least one computing device;
retrieving, by the processing unit in real-time, at least one content from a server associated with one or more external utilities;
determining, by the processing unit, a display space on a lock screen of the at least one computing device based on the one or more triggers;
and
dynamically displaying, by the processing unit, the at least one content on the determined display space on the lock screen of the at least one computing device.

2. The method as claimed in claim 1, wherein the retrieving is based on at least one of one or more user attributes associated with a user of the at least one computing device, a contextual state of the at least one computing device, and one or more predefined criterion.

3. The method as claimed in claim 1, wherein the one or more triggers comprise one or more of a lock screen state and a user inactivity.

4. The method as claimed in claim 1, wherein the display space comprises of a pre-determined area on the lock screen of the at least one computing device, and the at least one content is displayed on the pre-determined area.

5. The method as claimed in claim 1, wherein the at least one content is displayed in one of a custom format and a predetermined format on the determined display space on the lock screen of at least one the computing device, each format comprising at least one of an image, a tag, a main text and a subtext.

6. A system for displaying content on a lock screen of at least one computing device, the system comprising:
a processing unit connected to a storage unit, said processing unit configured to:
identify one or more triggers at the at least one computing device;
retrieve, in real-time, at least one content from a server associated with one or more external utilities;
determine a display space on a lock screen of the at least one computing device based on the one or more triggers; and
dynamically display the at least one content on the determined display space on the lock screen of the computing device.

7. The system as claimed in claim 6, wherein the processing unit is further configured to retrieve the at least one content based on at least one of one or more user attributes associated with a user of the at least one computing device, a contextual state of the at least one computing device, and one or more predefined criterion.

8. The system as claimed in claim 6, wherein the one or more triggers comprise one or more of a lock screen state and a user inactivity.

9. The system as claimed in claim 6, wherein the display space comprises of a pre-determined area on the lock screen of the at least one computing device, and the at least one content is displayed on the pre-determined area.

10. The system as claimed in claim 6, wherein the at least one content is displayed in one of a custom format and a predetermined format on the determined display space on the lock screen of at least one the computing device, each format comprising at least one of an image, a tag, a main text and a subtext.
